(19) United States
(12) Patent Application Publication
(10) Pub. No.: US 2015/0360866 A1
(43) Pub. Date: Dec. 17, 2015

(54) Building Block Carrier

(71) Applicant: Michael Patrick Dowdy, Huntsville, AL (US)

(72) Inventor: Michael Patrick Dowdy, Huntsville, AL (US)

(21) Appl. No.: 14/736,654

(22) Filed: Jun. 11, 2015

Related U.S. Application Data
(60) Provisional application No. 62/012,290, filed on Jun. 14, 2014.

(51) Int. Cl. B65G 7/12

(52) U.S. Cl. CPC B65G 7/12

(57) ABSTRACT

An improved device for lifting and transporting hollow-core building blocks by hand using a pair of rigid, U-shaped aims arranged parallel with one another at the base to engage the interior web surface of the block and tilted inwardly to converge into a single ergonomic handle directly above the block's center of gravity.

### CROSS REFERENCE TO OTHER APPLICATIONS

This application claims priority to, and the benefit of, pending U.S. Provisional Patent Application No. 62/012,290 filed on Jun. 14, 2014 titled “Building Block Carrier.”

### FIELD OF THE DISCLOSURE

The present disclosure pertains to the field of construction tools. More specifically, the present disclosure pertains to a carrier useful for carrying blocks or other construction materials.

### BACKGROUND

Building blocks such as concrete masonry units (“CMUs”) are designed in such a way as to facilitate ease of construction by allowing for the assembly of entire walls through an aggregate of smaller, individual units that are themselves maneuverable by the normal strength of a human laborer. There is, however, little attention given to anatomy of the human providing that maneuvering power, particularly in terms of load distribution through the body of the weight incurred by the block, and in the abrasiveness of the surface of the block. These shortcomings result in carrying positions (particularly in the hands and wrists) unsuited to the natural load-bearing configurations of the human body, leading to undue strain, fatigue, and skin abrasions.

Furthermore, the intent is to provide a tool of sturdy constitution, without delicate components such as hinges or other elements subject to stress concentration and subsequent failure under the rigors associated with a construction site.

There are currently many devices in use for conveying such building blocks, such as tongs, slings, and other mechanically operated lifting devices that seek to alleviate this unnecessary wear and tear on the human body. These systems, however, are often too complex, cumbersome, or costly to be used extensively in the field.

### BRIEF DESCRIPTION OF THE DRAWINGS

To further explain the advantages and features of the present disclosure, a more particular description of the invention will be rendered by reference to specific embodiments thereof which are illustrated in the appended drawings. It is appreciated that these drawings are not to be considered limiting in scope. The invention will be described and explained with additional specificity and detail through the use of the accompanying drawings in which:

FIG. 1 is a perspective view of the block carrier, the dashed lines showing a standard CMU building block in an engaged position with the carrier;

FIG. 2 is a cross-section view of the carrier taken perpendicular to its longitudinal axis;

FIG. 3 is a side elevation view of the carrier shown in operation by a worker, demonstrating how the device aligns the load of the building block with the natural bearing axis of the human body.

FIG. 4 is a rear elevation of a workman holding two loaded carriers in a natural grasping position balancing the load along the natural bearing axis of the body.

### SUMMARY OF THE DISCLOSURE

In a first aspect, the present disclosure provides an improved building block carrier, which facilitates the expeditious lifting and carrying of the manufactured block by applying its incurred load via a handle to the hands of a person in their natural grasping configuration and allowing the load to be transferred through the wrists in their natural suspended position, thereby allowing a more direct path of travel from the weight of the block to the arms (and ultimately to the support of the legs) and eliminating excess torque upon the hands and wrists.

In a second aspect, the present disclosure provides a carrier that is simple and economical to construct, consisting of elements that are inexpensive, readily available, and easily manipulated.

### DETAILED DESCRIPTION

This present disclosure relates to a tool or carrier 5 useful for carrying building blocks 10, such as CMUs, or other heavy materials fabricated with a hollow core 18 created in such a way as to allow the full weight of the CMU 10 or material to bear on the walls of that core 18, as is the case in carrying or other means of transportation by suspension.

A standard CMU or related building block (10) has a form consisting of two primary side walls 20 bridged by multiple web members 22 generally of the same depth and similar thickness as the primary side walls 20 and oriented perpendicular to those side walls 20. This creates a hollow core 18 within the structure of the block 10.

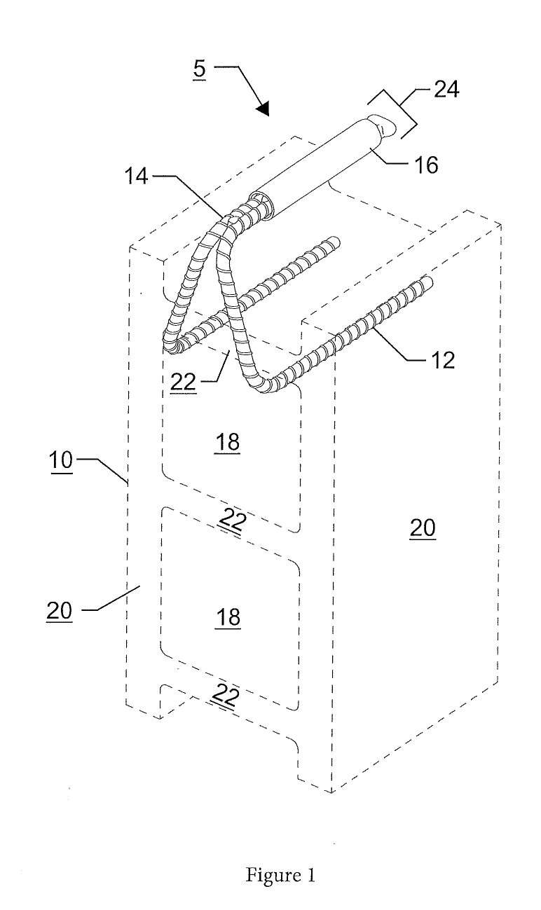

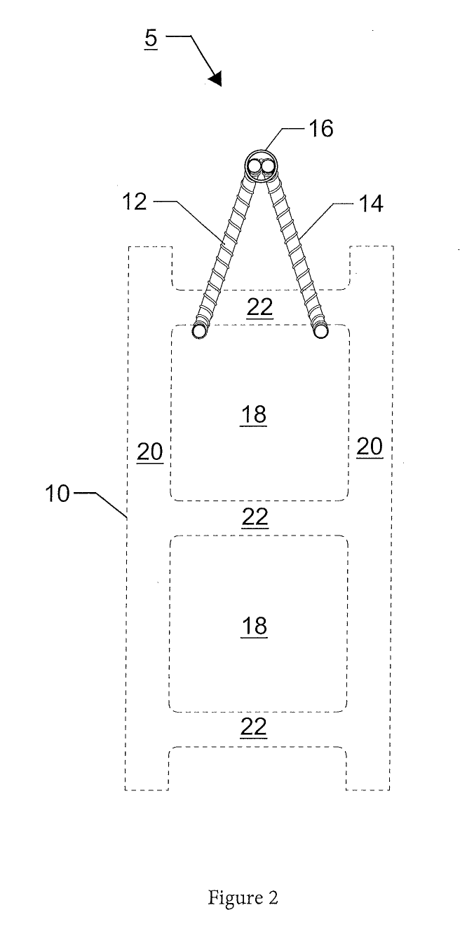

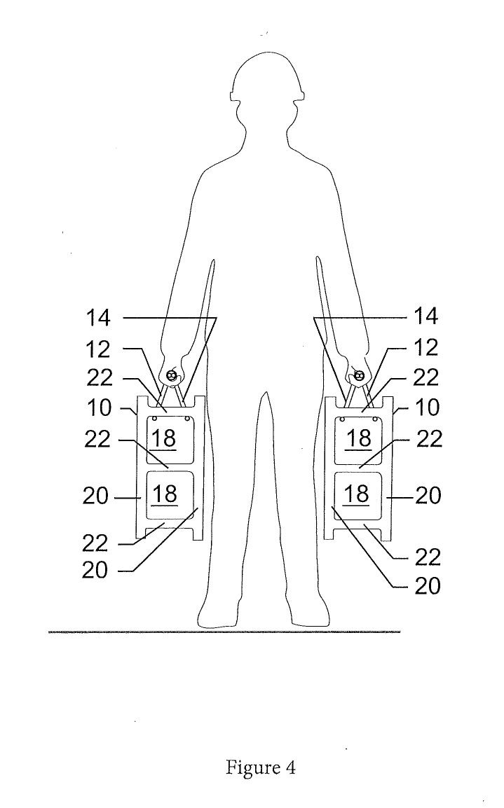

As shown in FIGS. 1-4, in some embodiments, the carrier 5 of the instant application comprises two rods 12, 14 (each comprising a first and a second end) of steel or other high-strength durable metal which penetrate the core 18 through its predefined opening and engage the inner surface of the outermost web member 22 of the block 10 such that when lifted, weight of the block 10 will transfer through the web member 22 to the rods 12, 14. In some embodiments the rods may comprise steel rebar or aluminum. Further, the carrier 5 may comprise more than two rods and in some embodiments the carrier may comprise three, four, five, six or more rods.

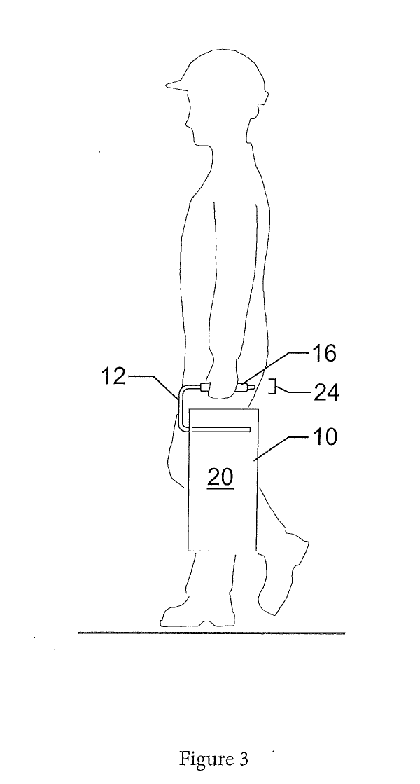

These rods 12, 14, which may be oriented parallel to each other, turn upwardly at an angle a after sufficient bearing surface has been established (generally at least ¾ of the depth of the block) until they reach a height such that when the block 10 is engaged a sufficient space is created above the block 10 to allow grasping by a human hand. At this point and under load, the rods 12, 14 may bend back again to run parallel with the surface of the web member on which the block 10 is bearing. Thus, the individual rods 12, 14 attain comprehensive U-shapes as viewed from the side when engaged with a block 10 (as shown in FIG. 3).

In some embodiments, the 12, 14 rods are in pairs to provide stability when transporting a block 10. So long as the weight of the block is distributed perpendicularly between the two rods 12, 14, the block 10 is not apt to swing or rotate during transit. However, to provide a single, readily graspable handle, the rods 12, 14 are angled toward one another in the front plane and, though separated at the bottom, are joined at the top by means of welding or other securing method that would be known to those of ordinary skill in the art that does not obstruct a fluid grasp by the hand.

Furthermore, in some embodiments in order to provide both additional reinforcement to the attachment and increased ergonomic comfort, a single hollow tube 16 is inserted and secured over the joined rods 12, 14 to form a grip 24. This tube 16 can be of metal, plastic, rubber, or other inexpensive yet durable material such as, but not limited to EMT or electrical conduit or PVC pipe. In alternate embodiments, the rods 12, 14 may be wrapped with soft, yet durable material such as a rubberized material which in some embodiments may be ergonomically formed to fit the human hand. In some embodiments this rubberized material may be soft or it may be hard.

From the above description, it will be clear that the present disclosure provides an exceedingly ergonomic, economical, endurant, and effective carrier which facilitates the transporting of building blocks or related elements under normal human power with minimal strain. This carrier can be manufactured from rebar or other metal rods and pre-manufactured tubing, either metal or sturdy plastic, and its composition is such that it is capable of not only withstanding high stresses associated with rough use, but also of quick and easy repair or replacement with on-hand materials. The orientation of the handle to allow for quick lifting and placing as well as for providing natural, ergonomic positioning of the wrists and hands is also paramount to the success of the carrier.

I claim:

1. A block carrying tool comprising:
a. a plurality of parallel rods which slidingly engage a block, said rods comprising a first end and a second end, wherein first ends of the rods are spaced apart from one another and are generally parallel with one another and the second end of the rods are in contact with one another and are located above the first ends; and
b. a grip comprising a cover placed over the second end of the rods, wherein the grip provides an ergonomic surface for grasping.

2. The tool of claim 1 wherein the plurality of parallel rods is 2.

3. The tool of claim 1 wherein the plurality of parallel rods is 3 or more.

4. The tool of claim 1 wherein the plurality of parallel rods is 4.

5. The tool of claim 1 wherein the rods comprise steel rebar.

6. The tool of claim 1 wherein the rods comprise aluminum.

7. The tool of claim 1 wherein the rods comprise at least one bend located between the first end and the second end.

8. The tool of claim 7 wherein the rods comprise at least two bends located between the first end and the second end.

9. The tool of claim 8 further comprising a grip which comprises a hollow tube slidingly fit over the second ends of the plurality of rods.

10. The tool of claim 9 wherein the hollow tube comprises electrical conduit.

11. The tool of claim 9 wherein the hollow tube comprises PVC pipe.

12. The tool of claim 9 wherein the second ends of the plurality of rods are joined together.

13. The tool of claim 12 wherein the second ends of the plurality of rods are welded together.

14. The tool of claim 8 further comprising a grip which comprises a rubberized covering over the over the second ends of the plurality of rods.

15. A block carrying tool comprised of laterally spaced parallel U-shaped arms tilted toward each other so as to form a pair of bearing tines that engage a building block through its core, the ventral ends of which extending past the center of gravity of the block and the dorsal ends converging together into a single handle which is covered and reinforced to allow for ease of grasping.

16. A tool for carrying construction materials with a hollow core, the tool comprising:
a. two (2) parallel steel rebar rods which slidingly engage the hollow core of the construction material, said rods comprising a first end and a second end, wherein first ends of the rods are spaced apart from one another and are generally parallel with one another and the second end of the rods are welded together and are located above the first ends, further wherein the rods comprise two (2) bends located between the first and second ends; and
b. a grip comprising a cover placed over the second end of the rods, wherein the grip provides an ergonomic surface for grasping.
